(19) United States
(12) Patent Application Publication
(10) Pub. No.: US 2025/0236926 A1
(43) Pub. Date: Jul. 24, 2025

(54) Grain-Oriented Electrical Steel Sheet and Method for Its Production

(71) Applicant: ThyssenKrupp Electrical Steel GmbH, Gelsenkirchen (DE)

(72) Inventors: Ludger Lahn, Moers (DE); Paul Betken, Bochum (DE)

(21) Appl. No.: 19/029,064

(22) Filed: Jan. 17, 2025

(30) Foreign Application Priority Data
Jan. 18, 2024 (EP) 24152561.7
Jan. 18, 2024 (IN) 202431003516

(51) Int. Cl. C21D 9/46; C21D 6/00; C21D 8/12; C22C 38/00; C22C 38/02; C22C 38/04; C22C 38/06; C22C 38/12; C22C 38/14; C22C 38/16; C23C 8/26; H01F 1/147

(52) U.S. Cl. CPC C21D 9/46; C21D 6/008; C21D 8/1222; C21D 8/1233; C21D 8/1255; C21D 8/1261; C21D 8/1283; C22C 38/001; C22C 38/002; C22C 38/02; C22C 38/04; C22C 38/06; C22C 38/12; C22C 38/14; C22C 38/16; H01F 1/14783; C21D 2201/05; C22C 2202/02; C23C 8/26

(57) ABSTRACT

A grain-oriented electrical steel sheet includes, in wt. %: Si: 2.0 to 4.0, Mn: 0.01 to 0.5, C: up to 0.005, Alₛₗ: up to 0.0030, N: up to 0.005; wherein the sum of C and N is max. 0.0065%; at least one element selected from the group consisting of V, Nb, Ti, Mo with the following contents, in wt. %, V: 0.0005 to 0.0060, Nb: 0.0005 to 0.0060, Ti: 0.0005 to 0.0030, Mo: 0.0005 to 0.040; in case the content of Mo is >0.010 wt. %, the sum of the contents of V, Nb, Ti and Mo is ≤0.040 wt. % and Cu is present in an amount of 0.02 to 0.6 wt. % and in case the content of Mo is ≤0.010% the sum of the contents of V, Nb, Ti and Mo is ≤0.030 wt. % and Cu is optionally present in an amount of 0.002 to 0.6 wt. %.

### CROSS-REFERENCE TO RELATED APPLICATIONS

This application claims priority to European Patent Application No. 24152561.7 filed Jan. 18, 2024, and Indian Patent Application No. 202431003516 filed Jan. 18, 2024, the disclosures of which are hereby incorporated by reference in their entireties.

### BACKGROUND OF THE INVENTION

### Field of the Invention

The present invention relates to a method for producing a grain-oriented electrical steel sheet and to a grain-oriented electrical steel sheet. In particular, the present invention relates to a grain-oriented electrical steel sheet with improved cold rollability and excellent electromagnetic properties.

Unless explicitly stated otherwise, in the present text the content of particular alloy elements is always reported in % by weight (=“wt. %”) or on ppm by weight (=“wt.-ppm”).

The terms “sheet” or “strip” are used in the present text synonymously to indicate a flat steel product which is obtained by a rolling process and which length and width is much greater than its thickness. Thus, all explanations given here with regard to a grain-oriented electrical steel sheet also apply for a grain-oriented electrical steel strip and vice versa.

Grain-oriented electrical steel (“GOES”) is a soft magnetic material, which typically exhibits high silicon contents. GOES has a high permeability to the magnetic field and can be magnetized and demagnetized easily.

Their magnetic properties make sheets or strips made from GOES material especially suited for manufacturing electric transformer cores with a minimum specific loss and a high achievable working induction, for example up to 1.85 T, for a wide range of sheet thicknesses, e.g., 0.10 to 0.35 mm.

### Description of Related Art

N. Chen et al., Acta Materialia 51 (2003), pages 1755 to 1765 and K. Günther et al., Journal of Magnetism and Magnetic Materials 320 (2008), 2411 to 2422, describe that GOES can be manufactured in different ways. An exemplary production route includes the following manufacturing steps:
a) Producing a steel by using a blast furnace and basic oxygen converter or by using an electric arc furnace;
b) metallurgy refining of the steel melt by using a vacuum degassing vessel;
c) casting the steel melt into an intermediate product, i.e., a common slab, a thin slab or a cast strip;
d) optionally reheating the intermediate product;
e) hot rolling the intermediate product to a hot rolled steel strip;
f) coiling the hot rolled steel strip into a coil;
g) coil surface preparation;
h) hot strip annealing and pickling of the hot rolled strip;
i) cold rolling the hot rolled strip in one or more passes to obtain a cold rolled strip with a final thickness;
j) decarburization annealing of the cold rolled strip;
k) optionally surface nitriding of the cold rolled strip;
l) applying a MgO coating to the surface of the cold rolled strip;
m) high temperature bell annealing of the MgO coated cold rolled strip to secondary recrystallize the cold rolled strip, the cold rolled strip being coiled to coils which for the bell annealing are stacked in a hood type furnace;
n) heat flattening and insulation coating of the annealed strip;
o) optionally magnetic domain refining of the strip.

According to the so called “High Heating” technology, the casting and the high temperature slab reheating is performed at temperatures of up to 1400° C. Such high temperature casting and reheating results in a well-developed inhibition system which comprises finely distributed particles of AlN, MnS and other compounds in the iron matrix even before the cold rolling process. The presence of these finely distributed inhibitor particles promotes an abnormal grain growth in the steel structure, which has a positive effect on the magnetic properties of the GOES sheet.

In the so called “Low Heating” technology the intermediate product is reheated at low temperatures below 1320° C. so that no or only a weak inhibition system is formed in the slab before hot rolling. This is due to the fact that the precipitations that form the inherent finely distributed inhibitor particles, such as, e.g., MnS, cannot be dissolved in ferrite and austenite at the low temperatures used prior to hot rolling and can therefore not be finely precipitated in the hot strip during hot rolling. For this reason, in the low heating technology a nitriding treatment of the cold rolled strip surface has to be performed after or during the decarburization annealing to form finely distributed inhibitor particles, which enable a secondary grain growth in the course of the high temperature bell annealing of the cold rolled strip.

The primary recrystallization (PRX) occurring during the decarburization annealing prepares and controls the secondary grain growth. However, this process step is unstable due to the large number of metallurgical phenomena that compete with each other during the decarburization annealing. These phenomena are in particular carbon removal, formation of the oxide layer and primary grain growth.

Nevertheless, it is known that decarburization annealing is essential to obtain efficient nitriding, a high-quality insulating forsterite film, and a sufficient number of Goss nuclei in the matrix. Furthermore, it is known that a dense oxide layer can promote surface quality but can also act as a barrier to decarburization and nitriding.

In the process step after the decarburization and nitriding step the steel strip runs through a high temperature annealing cycle either in a batch annealing furnace or a rotary batch annealing furnace. In the course of the high temperature annealing step secondary recrystallization (SRX) occurs and an abnormal grain growth takes place which leads to the Goss texture controlled by the inhibitor particles previously formed. Furthermore, disturbing elements, such as sulfur or nitrogen, are removed to minimize the presence of particles in the strip, that would otherwise negatively impact the magnetic properties, and a forsterite layer, also often called “glass film” is formed on the surface of the strip. This forsterite layer acts as an electric insulation coating layer and applies an additional tension on the surface of the strip, which contributes to the magnetic properties of the strip.

In a further process step, as known for example from DE 22 47 269 C3, a solution based on magnesium phosphate or aluminum phosphate or mixtures of both with various additives, such as chromium compounds and Si oxide, can be applied to the forsterite layer and baked at temperatures above 350° C. The layer system thus formed on the electrical steel forms an insulating layer, which transfers additional tensile stresses to the steel material that have a favorable effect on the electromagnetic properties of the electrical steel or sheet.

In recent years, there have been demands for thinner and thinner grain-oriented electrical steel sheets with further improved magnetic properties.

In order to decrease the final thickness of grain-oriented electrical steel sheets higher cold-rolling degrees are required. Increasing the cold-rolling degree, however, results in an increased amount of strip breakages as the steel compositions used for the production of grain-oriented electrical steel sheets are fairly brittle, in particular due to their silicon (Si) content, which is especially advantageous with regard to the magnetic properties of the grain-oriented electrical steel sheet.

In the prior art attempts to simultaneously achieve good cold-rollability of the hot strip and good magnetic properties of the final grain-oriented electrical steel have been carried out by adapting the equipment for the production of thin slabs. In this regard WO 2008/000396 A1 describes the inclusion of a double-stage pre-heating to arrive at a high rolling start temperature of above 1250° C. to improve the formation of inhibition particles in the hot-strip microstructure and WO 2009/012963 A1 describes the use of an additional pre-rolling mill and an additional induction heating to a temperature of 1200 to 1350° C. in order to improve workability as well as homogeneity of the final microstructure. The proposed prior art approaches have the disadvantage that they require a modification of existing production facilities to implement the additional equipment parts needed, which results in production downtime as well as modification costs. Such a modification may in some cases even be impossible due to space constraints.

### SUMMARY OF THE INVENTION

Against the background of the prior art explained above, the object of the present invention is to provide a method of producing a thin grain-oriented electrical steel strip from a thin slab having improved magnetic properties, which does not require the modification of existing production facilities.

The invention solved this problem by means of a method of producing a grain-oriented electrical steel sheet and a grain-oriented electrical steel sheet as described herein.

The general idea and advantageous embodiments of the invention are explained in detail below.

The method of producing the grain-oriented electrical steel sheet according to the present invention comprises at least the following working steps:
a) Providing a thin steel slab having a thickness of 30 to 140 mm with a composition comprising, in wt. %,
   Si: 2.0 to 4.0,
   C: 0.01 to 0.10,
   Alₛₗ: 0.01 to 0.065,
   N: 0.003 to 0.015,
   Mn: 0.01 to 0.5,
   at least one element selected from the group consisting of V, Nb, Ti, Mo with the following contents, in wt. %
   V: 0.0005 to 0.0060,
   Nb: 0.0005 to 0.0060,
   Ti: 0.0005 to 0.0030,
   Mo: 0.0005 to 0.040,
   wherein in case the content of Mo is >0.010 wt. %, the sum of the contents of V, Nb, Ti and Mo is ≤0.040 wt. % and Cu is present in an amount of 0.02 to 0.6 wt. % and wherein in case the content of Mo is ≤0.010% the sum of the contents of V, Nb, Ti and Mo is ≤0.030 wt. % and Cu may optionally be present in an amount of 0.002 to 0.6 wt. %,
   optionally one or more elements selected from the group consisting of Se, Sn, Sb, Bi, Ni, Co, wherein the individual content of each of these elements is 0.002 to 0.2 wt. %,
   optionally Cr in an amount of 0.002 to 0.60 wt. %,
   optionally S in an amount of 0.002 to 0.10 wt. %,
   optionally one or more elements selected from the group consisting of As, B, P, Te, wherein the individual content of each of these elements is 0.0003 to 0.1 wt. %, the remainder of the composition being Fe and unavoidable impurities;
b) heating of the thin steel slab in a furnace standing inline to a temperature ranging between 105° and 1320° C. for at most 60 min;
c) Continuous hot rolling of the thin steel slab obtained in step b) into a hot strip having a thickness of 0.5 to 4.0 mm in a multi-stand hot rolling mill standing inline, wherein the first rolling pass is carried out at a temperature of 900 to 1200° C. with a degree of deformation of more than 40%;
d) Cooling the hot strip by vapor and/or liquid spray cooling;
e) Coiling the hot strip;
f) Annealing the hot strip;
g) Cold rolling the hot strip in one or more steps into a cold strip, wherein the cold rolling optionally comprises an intermediate annealing;
h) Decarburization annealing of the cold strip;
i) Optionally nitriding annealing during or after decarburization annealing;
j) Applying an annealing separator onto at least one surface of the cold strip;
k) Final annealing of the cold strip;
l) Optionally coating of the annealed cold strip with an electric insulation coating and annealing of the insulation coated cold strip;
m) Optionally performing domain refinement of the coated cold strip.

The method of the invention may comprise further steps that are known to the skilled person and that are usually performed when producing grain-oriented electrical steel sheets.

The invention is based here on the realization that improved cold rollability of the hot strip and improved magnetic properties of the final grain-oriented electrical steel strip according to the invention can be ensured by carefully balancing the amount of Mo and the amount of the microalloying elements V, Nb and Ti as well as the amount of Cu in the steel composition as well as the process conditions in steps b) to e) of the method.

It was observed that carefully balancing the amount of Mo and the amount of V, Nb and Ti as well as the amount of Cu in the steel composition of step a) and the process conditions in steps b) to e) allows the formation of carbonitrides, carbides and nitrides of the microalloying elements and of CuS and/or Cu₂S as additional inhibitor particles next to the classical inhibitor particles MnS and AlN. The formation of the additional carbonitride and nitride inhibitor particles leads to a reduction of free nitrogen in the steel, which improves the cold-rollability of the hot strip and improves the magnetic properties of the final grain-oriented electrical steel sheet.

A careful balance of steps b) to e) and of the elements Mo, V, Nb, Ti and Cu in the steel is necessary as the amount of carbonitride inhibitor particles formed thereof should not be too high as due to their high solubility temperature the carbonitride particles do not dissolve during final annealing in step j). A too high number of these inhibitor particles will therefore negatively impact the magnetic properties of the final grain-oriented electrical steel sheet.

The combination of measures according to the invention in the production of the grain-oriented electrical steel strip, especially in steps a) to e) of the method of the invention, make it possible to reliably achieve improved cold-rollability of the hot strip while at the same time achieving excellent magnetic properties of the final grain-oriented electrical steel sheet.

In step a) of the method of the invention a steel slab is provided with a composition comprising, in wt. %,
Si: 2.0 to 4.0,
C: 0.01 to 0.10,
Alₛₗ: 0.01 to 0.065,
N: 0.003 to 0.015,
Mn: 0.01 to 0.5,
at least one element selected from the group consisting of V, Nb, Ti, Mo with the following contents, in wt. %
V: 0.0005 to 0.0060,
Nb: 0.0005 to 0.0060,
Ti: 0.0005 to 0.0030,
Mo: 0.0005 to 0.040,
wherein in case the content of Mo is >0.010 wt. %, the sum of the contents of V, Nb, Ti and Mo is ≤0.040 wt. % and Cu is present in an amount of 0.02 to 0.6 wt. % and
wherein in case the content of Mo is ≤0.010% the sum of the contents of V, Nb, Ti and Mo is ≤0.030 wt. %, preferably 0.020 wt. %, and Cu may be optionally present in an amount of 0.002 to 0.6 wt. %,
optionally one or more elements selected from the group consisting of Se, Sn, Sb, Bi, Ni, Co, wherein the individual content of each of these elements is 0.002 to 0.2 wt. %,
optionally Cr in an amount of 0.002 to 0.60 wt. %,
optionally S in an amount of 0.002 to 0.10 wt. %,
optionally one or more elements selected from the group consisting of As, B, P, Te, wherein the individual content of each of these elements is 0.0003 to 0.1 wt. %,
   the remainder of the composition being Fe and unavoidable impurities.

The thin steel slab may be provided in step a) of the method of the invention using conventional means in the art, e.g., a slab caster. 2.0 to 4.0% by weight silcon (Si) is present in the steel slab provided in step a) according to the method of the invention. A silicon content of 2.5 to 3.5% by weight has proven to be especially advantageous with regard to the magnetic properties of a grain-oriented steel sheet according to the invention. Si is needed to improve the permeability of the grain-oriented electrical steel sheet. A Si content below 2.0% by weight is insufficient for getting a high permeability and thus a low iron loss. If the Si content is above 4.0% by weight, the workability of the sheet is degraded, meaning the sheet is more brittle and more likely to break during cold rolling or other process steps.

According to the present invention, the amount of carbon (C) in the steel slab provided in step a) is 0.01 to 0.10% by weight, particularly preferably 0.03 to 0.08% by weight. C is used to improve the hot rolled structure of the steel by promoting the formation of austenite. Additionally, C is needed during cold rolling to act as an inhibitor for dislocation movements, thus acting as a driver for recrystallization. Therefore, the C amount should be at least 0.01% by weight. Too high C amounts above 0.10% by weight, however, lead to problems during decarburization annealing and to increased iron loss and should therefore be avoided. 0.01 to 0.065% by weight of aluminum (Alₛₗ) is present in the steel slab provided in step a) according to the method of the invention. An aluminum content of 0.015 to 0.050% by weight has proven to be especially advantageous with regard to an optimal content and size of inhibitor particles that inhibit the grain growth and result in a favorable grain orientation of the finished GOES. Aluminum content below 0.01 wt. % results in few inhibitor particles and thus in a weak inhibition of grain growth during final annealing of the cold strip. A too high amount of aluminum of more than 0.065% by weight leads to coarse inhibitor particles, which also leads to a weak inhibition of grain growth during final annealing of the cold strip.

According to the present invention, nitrogen (N) is present in the steel slab provided in step a) in an amount of 0.003 to 0.015% by weight, particularly 0.0035 to 0.013% by weight. N is needed as an inhibitor forming element, which together with Al leads to the formation of AlN. If the N content is lower than 0.003% by weight, the inhibition is insufficient. Higher N contents than 0.015% by weight lead to problems during rolling and a bad surface quality due to an increased number of rolling breakages. 0.01 to 0.5 weight % manganese (Mn) is present in the steel slab provided in step a) of the method of the invention. A manganese content of 0.05 to 0.3% by weight, preferably of 0.05 to 0.25% by weight, has proven to be especially advantageous. The addition of at least 0.01% by weight of Mn decreases the iron loss by increasing the specific resistance of the grain-oriented electrical steel sheet and improves the hot workability of the steel. A Mn content above 0.5% by weight decreases the magnetic flux density of the grain-oriented electrical steel sheet and should therefore be avoided.

According to the present invention the composition of the thin steel slab comprises at least one element selected from the group consisting of vanadium (V), niobium (Nb), titanium (Ti) with the following contents, in wt. %, V: 0.0005 to 0.0060, Nb: 0.0005 to 0.0060, Ti: 0.0005 to 0.0030. It has been found that addition of more than 0.0060 wt. % V and/or Nb and/or more than 0.0030 wt. % Ti leads to deterioration of the magnetic properties of the grain-oriented steel sheet as a too high amount of carbonitride inhibitor particles is formed with the microalloying elements in the microstructure of the steel that cannot be removed during the final annealing of the cold-strip in step k). In case the composition of the steel slab comprises less than 0.0005 wt. % V, Nb and/or Ti this can lead to deterioration of the cold rollability of the hot strip due to the presence of unbound nitrogen in the steel, as unbound nitrogen diffuses to dislocations in the steel structure during cold rolling resulting in a hardening of the strip. Thus, resulting in an increased number of breakages during cold rolling. According to a preferred embodiment of the invention the thin steel slab comprises at least one element selected from the group consisting of V, Nb, Ti with the following contents, in wt. %, V: 0.0010 to 0.0060, Nb: 0.0010 to 0.0060, Ti: 0.0010 to 0.0030.

0.0005 to 0.040 wt. % molybdenum (Mo) is present in the composition of the steel slab, wherein the amount of Mo influences the total amount of Ti, V and Nb in the steel slab as described below. Mo suppresses high-temperature corrosion by forming a thin layer of MoSi₂ on the surface of the steel strip, thereby suppressing further formation of scale. Mo has a higher segregation coefficient compared to the microalloying elements V, Nb and Ti.

Addition of more than 0.040 wt. % Mo results in deterioration of cold rollability of the hot strip as Mo decreases the diffusion coefficient of C, which results in an increased number of carbides being present in the hot strip and in an increased risk of red-shortness during hot rolling. An amount of below 0.0005 wt. % of Mo results in insufficient inhibition of oxidation and to increased scale formation during hot rolling. According to a preferred embodiment of the invention the thin steel slab comprises 0.0010 to 0.015 wt. % Mo.

In case the content of Mo is >0.010 wt. %, the sum of the contents of V, Nb, Ti and Mo is ≤0.040 wt. % and copper (Cu) is present in an amount of 0.02 to 0.6 wt. % and in case the content of Mo is ≤0.010% the sum of the contents of V, Nb, Ti and Mo is ≤0.030 wt. %, preferably 0.020 wt. %, and Cu may optionally be present in an amount of 0.002 to 0.6 wt. %.

The presence of Mo in an amount of >0.010 wt. % inhibits the formation of austenite resulting in a weakened intrinsic inhibition. To ensure sufficient intrinsic inhibition in case more than 0.010 wt. % Mo is present in the composition of the thin steel slab Cu is additionally added to the steel slab in an amount of 0.02 to 0.6 wt. % resulting in the formation of additional CuS/Cu₂S inhibitor particles. The addition of Cu is not necessary in case the amount of Mo in the thin steel slab is below or equal to 0.010 wt. %. In addition, in case more than 0.010 wt. % Mo is present in the steel slab, the sum of the contents of V, Nb, Ti and Mo is restricted to 0.040 wt. % to ensure good magnetic properties of the resulting grain-oriented steel strip.

The sum of the content of unavoidable impurities in the steel slab provided in step a) of the method of the present invention is preferably restricted to less than 0.5% by weight, more preferably to less than 0.3% by weight.

In addition to Fe, Si, C, Alₛₗ, N, Mn and at the at least one element selected from the group of V, Nb, Ti and Mo and unavoidable impurities, the steel slab provided in step a) according to the method of the invention optionally comprises one or more elements selected from the group consisting of Se, Sn, Sb, Bi, Ni, Co, wherein the individual content of each of these elements is 0.002 to 0.2 wt. %, optionally Cr in an amount of 0.002 to 0.60 wt. %, optionally S in an amount of 0.002 to 0.10 wt. %, optionally one or more elements selected from the group consisting of As, B, P, Te, wherein the individual content of each of these elements is 0.0003 to 0.1 wt. %.

Selenium (Se) together with Mn forms MnSe, which serves as an inhibitor for recrystallization. This supports the formation of the final Goss texture and thus improves the iron loss in the final grain-oriented electrical steel sheet. To securely achieve this effect the content of Se in the steel slab provided in step a) according to the method of the invention has to be at least 0.002 wt. %. A content of more than 0.2 wt. % Se leads to coarse MnSe particles whose inhibiting effect is not sufficient to effectively hinder recrystallization. Preferably, Se may be comprised in the composition of the steel slab provided in step a) according to the method of the invention in an amount of 0.002 to 0.10 wt. %.

Tin (Sn) improves the magnetic quality of the grain oriented electrical steel sheet by stabilizing the formation of the oxide layers and the glass film (forsterite film) and can be included in the composition of the steel slab provided in step a) according to the method of the invention in an amount of at least 0.002 wt. %. An amount of Sn above 0.2 wt. % decreases the oxidation and a stable glass film (forsterite film) cannot be formed. Preferably, tin may be comprised in the composition of the steel slab provided in step a) according to the method of the invention in an amount of 0.005 to 0.15 wt. %.

Antimony (Sb) can optionally be added to interfere with grain boundary movements as a segregation element and acts to inhibit grain growth, influencing the recrystallization and final Goss texture of the grain-oriented steel sheet. This effect can securely be achieved in case an amount of at least 0.002 wt. % Sb is comprised in the composition of the steel slab provided in step a) according to the method of the invention. An Sb content in the composition of the steel slab provided in step a) according to the method of the invention of more than 0.2% increases the likelihood of strip breakage during rolling and, due to its oxidation-inhibiting effect may further lead to an uneven glass film formation. Preferably, Sb may be comprised in the composition of the steel slab provided in step a) according to the method of the invention in an amount of 0.002 to 0.15 wt. %.

Ni, Co, As, B, Bi, P and Te support the inhibition effect during secondary recrystallization and thus have a positive influence on iron loss. To obtain this effect, the respective minimum contents of these elements given further above must be observed. Excessively high contents of these elements lead to cleaning problems during high-temperature annealing and, in some cases, to impaired cold-rollability. Preferably, Bi, Ni and Co may be comprised in the composition of the steel slab provided in step a) according to the method of the invention in an amount of 0.005 to 0.15 wt. %, while As, B, P and Te may preferably be comprised in the composition of the steel slab provided in step a) according to the method of the invention in an amount of 0.0003 to 0.02 wt. %.

In step b) of the method of the invention the thin steel slab provided in step a) is heated in a furnace standing inline to a temperature ranging between 105° and 1320° C. for at most 60 min. An inline standing furnace as used herein is a furnace that is placed in a direct line to the slab caster providing the thin steel slab upstream in step a) and that continuously provides the thin steel slab obtained in step b) downstream to the multi stand hot rolling mill used for continuous hot rolling of the thin steel slab into a hot strip in step c) of the method of the invention. Preferably the heating in step b) of the method of the present invention is carried out for a duration of 5 to 60 min. A duration of less than 5 min leads to insufficient and inhomogeneous heating through resulting in difficult hot workability. A duration of more than 60 min can lead to unwanted scale formation on the hot strip and growth of inhibitor particles resulting in an insufficient grain growth selection in step k). According to a preferred embodiment of the method of the invention the slab surface temperature at inline furnace entrance is between 800° C. and 1130° C.

In case the steel slab provided in step a) is heated in a furnace to a temperature below 1050° C. intermetallic phases are agglomerated below the surface at the grain boundaries, which impedes Bloch wall movement and leads to poor polarization of the GOES due to deformation of the hysteresis curve. Temperatures above 1320° C. lead to poor hot workability as rollers become soiled due to liquid slag.

In step c) of the method of the invention the thin steel slab obtained in step b) is continuously hot rolled into a hot strip having a thickness of 0.5 to 4.0 mm in a multi-stand hot rolling mill standing inline, wherein the first rolling pass is carried out at a temperature of 900 to 1200° C. with a degree of deformation of more than 40%. The degree of deformation is determined according to the usual method in the art by determining the thickness of the slab prior to the first rolling pass and the thickness of the hot strip after the first rolling pass and calculating the degree of deformation. The hot strip achieved in step c) of the method according to the invention preferably has a thickness of 1.5 to 3.5 mm, most preferably of 1.8 to 2.7 mm. According to a preferred embodiment of the method of the invention no pre-rolling is carried out.

In step d) of the method of the invention the hot strip obtained in step c) is cooled by vapor and/or liquid spray cooling.

In step e) of the method of the present invention the hot strip is coiled. Preferably, the coiling temperature is from 500° C. to 780° C. Temperatures above 780° C. may lead to undesirably coarse precipitates and worsen the pickling properties of the strip. Temperatures below 500° C. can lead to breakages during coiling and require more force for coiling.

It has been found to be particularly advantageous if the hot strip resulting after step e) and prior to step f) has a bending number (BN) of ≥5 measured at the middle of the strip width and a bending number (BN) of ≥6 measured at both ends of the strip in strip width direction 25 mm from the respective end before the occurrence of a crack, determined according to DIN EN ISO 7799 with a bending radius of 5 mm. The sample used for determining the bending number has preferably the following dimensions: Sample width transverse to the rolling direction: 30 mm, sample length in rolling direction: 110 mm.

According to a preferred embodiment of the method of the invention the ratio of the average roughness Ra_{T} and the average roughness Ra_{R} of the hot strip resulting after step e) and prior to step f) satisfies the following formula:

$$0.5 \leq {Ra}_{T} / {Ra}_{R} \leq 1.75$$

and wherein the average roughness Ra_{T} is measured transverse to the rolling direction on the top and bottom side of the strip, in each case at least 15 m from the strip head or at least 15 m from the strip end with a measuring distance of 100 mm according to DIN EN ISO 4287:2010, an average value being formed from these measurements, and the average roughness Ra_{R} is measured in rolling direction on the top and bottom side of the strip, in each case at least 15 m from the strip head or at least 15 m from the strip end with a measuring distance of 100 mm according to DIN EN ISO 4287:2010, an average value being formed from these measurements. A roughness ratio Ra_{T}/Ra_{R} of higher than 1.75 can cause coil breakages during cold rolling as regions with high roughness are the source for crack initiations. If the roughness ratio Ra_{T}/Ra_{R} is below 0.50, the number of nuclei for oxidation during primary recrystallization is too low resulting in inhomogeneous oxide layer formation and thereby resulting in a poor glass film quality. In a preferred embodiment of the patent, the minimum roughness ratio Ra_{T}/Ra_{R} is 0.60 and the maximum roughness ratio Ra_{T}/Ra_{R} is 1.30. Preferably the average roughness of the top and bottom side Ra irrespective of the rolling direction is between 0,15 and 3,0 μm.

In step f) of the method according to the invention, the hot strip is annealed. Preferably the hot strip is annealed in a single or multi-step annealing, wherein the maximum temperature is at 800 to 1200° C. and the hot strip is annealed in total for 30 seconds to 6 minutes. In case of a multi-step annealing, the temperature in the first step is at least 100 K higher than the temperature of the next step or steps. The cooling rate after annealing from the maximum temperature in the last annealing step to 300° C. is between 10 K/s and 100 K/s, the strip at least partially being water-cooled with the water having a pressure higher than 3 bar. A maximum temperature between 800° C. and 1200° C. is especially favorable as it simultaneously allows improved homogenization of the strip and good handling properties of the strip. An annealing time between 30 s and 6 minutes has been found to be particularly advantageous to allow improved homogenization of the strip while avoiding decarburization of the strip.

According to step g) of the method of the invention the hot strip is cold rolled in one or more passes into a cold strip, wherein the cold rolling optionally comprises an intermediate annealing. The hot rolled strip may for example be cold rolled in at least three passes in a single stage rolling or in a multi-stage rolling to obtain a cold rolled strip. As used herein “single stage rolling” is cold rolling in at least three passes, wherein no intermediate annealing takes place between individual passes. As used herein “multi-stage rolling” is cold rolling in at least three passes in total, wherein the hot-rolled strip is cold rolled to an intermediate thickness, an intermediate annealing takes place, and after the intermediate annealing the strip is further cold-rolled to the final thickness and wherein the at least three rolling passes refer to the entire process of multi-stage rolling until reaching the final thickness of the cold strip including cold rolling prior and after intermediate annealing. Methods for cold rolling a grain-oriented steel strip are generally known to the skilled expert as well and, for example, described in WO 2007/014868 A1 and WO 99/19521 A1. Typically, an intermediate annealing is performed in a temperature range of 700 to 1200° C., preferably 800 to 1150° C., under an atmosphere which dew point is set to 10 to 80° C. Typical annealing times are 30s to 900 s. Installations with which such annealing can be performed are generally known and disclosed, for example, in WO 2007/014868 A1 and WO 99/19521 A1. Preferably, the temperature T_{CR} is between 175 and 480° C., more preferably between 20° and 380° C. The temperature T_{CR} as used herein is the temperature of the surface of the strip determined directly after third and second last pass before reaching the final steel thickness.

Typically, the thickness of the cold strip is 0.15 to 0.5 mm, preferably a maximum thickness of 0.35 mm, preferably of 0.27 mm at most or of 0.23 mm at most, are especially favorable.

According to a preferred embodiment of the method of the invention depending on the amount of Si, in wt. %, in the thin steel slab provided in step a) the number of cold-rolling breakages (CRB) in the cold-rolled strip after step g) satisfies the following formulae:

$$for 2. < Si < 3.1 \qquad CRB / \vert ( 2. - Si ) \vert < 25$$

$$for 3.1 \leq Si \leq 3.26 \qquad CRB / \vert ( 2. - Si ) \vert < 30$$

$$\begin{matrix}for 3.26 \leq Si \leq 4. & CRB / \vert ( 2. - Si ) \vert < 35\end{matrix} ,$$

wherein CRB is the number of cold-rolling breakages per 1000 t cold-rolled strip after step g). The CRB is determined by identifying the amount of cold rolling breakages in 100 t cold-rolled strip and extrapolating it to 1000 t cold-rolled strip, i.e., multiplying the actual amount of cold rolling breakages determined for 100 t of cold-rolled strip by 10.

In working step h) of the method according to the invention decarburization annealing of the cold rolled strip obtained in step g) takes place. This decarburization annealing may optionally include a nitriding treatment. The decarburization annealing is preferably carried out at temperatures in the range of 600 to 980° C., more preferably of 600 to 900° C. The duration of the decarburization annealing is preferably 30 to 300 s. The decarburization annealing is typically carried out using a high dew point atmosphere with a dew point between 4° and 80° C., preferably between 4° and 65° C. A dew point of more than 80° C. cannot be set in industrial settings, while with a dew point below 40° C. the resulting oxide layer becomes too dense and all surface-controlled chemical reactions, e.g. decarburization, nitriding, de-nitriding, can no longer take place as desired. The atmosphere may comprise 5 to 95 Vol.-% H₂, the remainder being nitrogen or any inert gas or a mix gas.

If a nitriding treatment is to be performed the annealing can be carried out under an atmosphere, which comprises N₂ or N-comprising compounds, for example NH₃. Annealing and nitriding can be conducted in two separate steps one after the other with the annealing being performed at first. As an alternative annealing and nitriding can be performed simultaneously.

If nitriding is performed in working step i) the conditions of the nitriding treatment should be adjusted such that a nitriding degree of up to 850 ppm, preferably up to 400 ppm, more preferably 20 to 400 ppm, is achieved. The nitriding degree is calculated as the difference between the nitrogen content of the steel strip before the final annealing (working step j)) minus the nitrogen content before the decarburization annealing (working step h)). The nitrogen content can be determined by usual means, such as using a 736 analyzer offered by Leco Corporation, St. Joseph, USA.

In step j) of the method according to the invention an annealing separator is applied onto at least one surface of the cold strip obtained in step h) or i). Typically, the annealing separator comprises MgO and optionally oxides and mixed oxides of iron, aluminum, titanium, magnesium and/or silica. The annealing separator comprising MgO and optionally oxides and mixed oxides of iron, aluminum, titanium, magnesium and/or silica applied to the cold-rolled steel strip to produce the forsterite layer during annealing in step k) in a manner known per se can consist of at least 70% by weight MgO, optionally up to 25% by weight of oxides and mixed oxides of iron, aluminum, titanium, magnesium and/or silica and can further contain up to 5% by weight additives, based on the total dry weight of the annealing separator. These additives may be, for example, elements like Ca, B and Sr, ammonium chloride or antimony chloride, and other salts like magnesium sulfate or sodium chloride, the addition of which controls the density of the subsequent forsterite layer and the gas exchange between the annealing atmosphere during high temperature annealing and the metal.

In step k) of the process according to the invention the cold rolled strip obtained in step h) or i) and coated with the annealing separator in step j) undergoes a final annealing during which the forsterite layer is formed, and secondary recrystallization occurs. The final annealing of the cold strip in step k) according to the method of the invention takes place at a maximum soaking temperature of at least 1076° C. but less than 1247° C. Temperatures below 1076° C. are insufficient for dissolving residual elements such as N or S, which would otherwise deteriorate the final magnetic properties of the GOES. Final annealing temperatures above 1247° C. lead to unwanted physical deformations of the steel strip due to decreased hardness of the steel.

This final annealing can also be carried out in a manner known per se. For this purpose, the cold-rolled steel strip obtained after step h) or i) and coated with the annealing separator in step j) can be wound into a coil and kept in a bell furnace for 10-200 hours at a maximum soaking temperature of 1076-1247° C. For example, the strip or sheet that is obtained after step j) can be rapidly heated to a maximum soaking temperature of 1150° C. or above, wherein maximum soaking temperatures of at least 1200° C. are particularly advantageous.

The heating and soaking are preferably carried out under a protective gas atmosphere, which, for example, comprises H₂. Particularly preferably, the heating to and soaking at the respective soaking temperature is performed under an induced atmosphere which comprises 5 to 95 Vol.-% H₂, the remainder being nitrogen or any inert gas or a mix gas, the dew point of the atmosphere being at least 10° C. Performing soaking in this way results in the removal of atoms of elements, which would otherwise deteriorate the properties of the grain-oriented electrical steel sheet. These elements are in particular N and S.

After the final annealing the steel strip is cooled down in a common manner, e.g., by natural cooling.

In step k) of the process according to the invention the secondary recrystallization takes place, which ensures that the grain-oriented steel sheet processed in this way is prepared to reliably develop the optimized properties of a grain-oriented steel sheet according to the invention as outlined above.

In addition, according to a preferred embodiment of the method of the invention, after step k) the steel strip is cleaned, and optionally pickled. Methods with which the steel strip is pickled are known to the skilled expert. For pickling the steel strip can be treated with an aqueous acidic solution. Suitable acids are for example phosphoric acid, sulfuric acid and/or hydrochloric acid.

In optional step 1) of the method of the invention the annealed cold strip obtained in step k) of the method of the invention is coated with an electric insulation coating and the insulation coated strip is annealed. The insulating layer is preferably applied on at least one side of the GOES. The method for applying the insulating layer is known to the artisan and can be found in, e.g., EP 2 902 509 B1 and EP2 954 095 A1. An insulation coating applied to a grain oriented electrical steel product has a positive effect on minimization of the hysteresis losses. The insulation coating can transfer tensile stresses to the base material, which not only improves the magnetic loss values of the grain oriented electrical steel product but also reduces the magnetostriction, thereby having in turn a positive effect on the noise behavior of the finished transformer. Formation of the insulation coating involves applying e.g., an aqueous solution of metallic phosphate containing colloidal silica and optional chromium compounds onto the surface of the steel sheet and baking the same at temperatures in the range of 500° C. to 950° C. for 10 to 600 s.

According to optional step m) of the method of the invention a domain refinement, preferably transverse to the rolling direction, is performed. The method for domain refinement by laser or electron beam treatment is known to the skilled person and can be found in, e.g., in EP 2 675 927 A1. For example, during laser treatment, linear strains, which are arranged with a spacing, are formed into the surface of the flat steel product by means of a laser beam emitted by a laser beam source, thereby decreasing the length of the domains and reducing the losses of the grain-oriented electrical steel sheet.

According to the present invention, at the end of the method explained above, the grain-oriented electrical steel sheet has a polarization J₈₀₀ of at least 1.89 T determined according to IEC 60404-3 and an iron loss P_{1.7}≤0.85 W/kg determined according to IEC 60404-3.

The chemical composition of the steel bulk of the grain-oriented electrical steel sheet, in wt. %, is as follows:
Si: 2.0 to 4.0,
Mn: 0.01 to 0.5,
C: up to 0.005,
Alₛₗ: up to 0.0030,
N: up to 0.005;
wherein the sum of C and N is max. 0.0065%;
at least one element selected from the group consisting of V, Nb, Ti, Mo with the following contents, in wt. %, V: 0.0005 to 0.0060, Nb: 0.0005 to 0.0060, Ti: 0.0005 to 0.030, Mo: 0.0005 to 0.040;
wherein in case the content of Mo is >0.010 wt. %, the sum of the contents of V, Nb, Ti and Mo is ≤0.040 wt. % and Cu is present in an amount of 0.02 to 0.6 wt. % and wherein in case the content of Mo is ≤0.010% the sum of the contents of V, Nb, Ti and Mo is ≤0.030 wt. %, preferably 0.020 wt. %, and Cu is optionally present in an amount of 0.002 to 0.6 wt. %; optionally S in an amount of max. 0.002 wt. %;
optionally one or more elements selected from the group consisting of Se, Sn, Sb, Bi, Ni, Co, Mg, wherein the individual content of each of these elements is 0.002 to 0.2 wt. %; optionally Cr in an amount of 0.002 to 0.60 wt. %;
optionally one or more elements selected from the group consisting of As, B, P, Te, wherein the individual content of each of these elements is 0.0003 to 0.1 wt. %, the remainder of the composition being Fe and unavoidable impurities.

In contrast to the composition of the steel slab used in step a) of the method according to the invention the composition of the resulting grain-oriented electrical steel sheet does contain C, N and S only as unavoidable impurities as these elements are dissolved out of the steel during steps f), h), i) and k) of the method of the invention. Alₛₗ is reduced compared to the analysis of the steel slab as Alsl before final annealing in connected to N and forms AlN inhibitor particles. During final annealing these are dissolved and the Alₛₗ diffuses to the surface and either forms non-soluble oxides or non-soluble mixed molecules with other elements. Thereby, the maximum amount of Alₛₗ in the grain-oriented electrical steel sheet is reduced to equal or below 30 ppm.

The grain oriented electrical steel sheet may also be characterized by a coarse grain structure in which up to 30% of the grain area in relation to the total area of the grains in the steel are occupied by grains having a grain size, measured according to DIN EN ISO 643 in rolling direction, of ≥50 mm. In case more than 30% of the grain area in relation to the total grain area of the grains in the steel is occupied by grains having a grain size of 50 mm this results in poor iron loss properties of the grain-oriented electrical steel sheet due to an increased magnetic domain size.

Preferably, the grain-oriented electrical steel sheet of the invention shows an increase in iron loss P_{1.7} of ≤1.0% after performing an aging test with Epstein samples of the grain-oriented electrical steel sheet for 24 h at a temperature of 225° C. in ambient atmosphere. In order to perform this test, samples of a grain-oriented electrical steel are taken and cut into Epstein samples having the dimension of 280 mm in rolling direction and 30 mm in transversal direction. Cutting can induce internal stress, which deteriorates the iron loss. Therefore, a stress relief annealing is done, which also allows to neglect the iron loss improvement by a potential domain refinement by laser or other methods, which are non-heat resistant. During stress relief annealing, the samples are annealed at 850° C. for 30 min in a 100% N₂ atmosphere and cooled to room temperature with a maximum cooling rate of 30 K/h. After cooling to room temperature, the samples are measured in an Epstein measurement device and the iron loss is measured according to IEC 60404-2. After that, the samples are annealed for 24 h at a temperature of 225° C. in ambient atmosphere. Again, the iron loss of the samples is measured. The deterioration of iron loss P_{1.7} after this procedure is preferably 1.0%.

According to a preferred embodiment of the invention the grain-oriented electrical steel sheet has a bending number (BN) of ≥30 before the occurrence of a crack, determined according to DIN EN ISO 7799 with a bending radius of 5 mm, preferably using a sample width transverse to the rolling direction of 30 mm and a sample length in rolling direction of 280 mm. The bending number is a quantitative description of the ductility of the final grain-oriented steel strip. Ductility is a standard demand of transformer producers as grain-oriented electrical steel strips with high ductility show a better workability during transformer production.

According to the present invention, the grain-oriented electrical steel sheets can be prepared in any format, like steel strips that are provided as coils, or cut steel pieces that are provided by cutting these steel pieces from the steel strips. Methods to provide coils or cut steel pieces are known to the skilled expert.

The grain-oriented electrical steel sheet produced according to the method of the present invention shows improved cold rollability and improved magnetic properties and can be manufactured without modification of existing production facilities.

### BRIEF DESCRIPTION OF THE DRAWINGS

The invention is explained further using the following FIGURE.

FIG. 1 SEM image of the surface of the hot strip of sample 4-1

### DESCRIPTION OF THE INVENTION

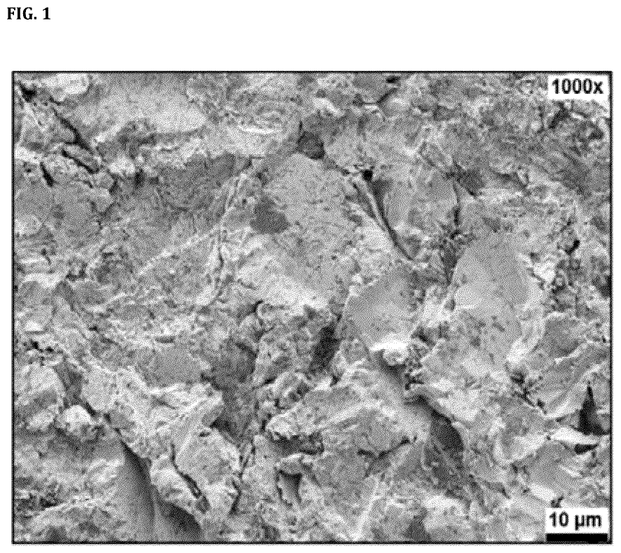

In FIG. 1 a Scanning Electron Microscope (SEM) image of the surface of the hot strip of sample 4-1 prior to hot strip annealing in accordance with step f) of the method of the invention is shown to illustrate its roughness.

Experiments have been carried out to demonstrate the effect of the invention.

In these experiments, 8 heats and three slabs per heat were produced having the composition as shown in Table 1 with slab thickness of 65 mm. These slabs were heated in an inline furnace at a temperature of 1100° C. for 20 min, continuously hot-rolled into a hot strip having a thickness of 2.2 mm, wherein the first rolling pass has been carried out at a temperature of 1050° C. with a degree of deformation of 43%, cooled, and coiled into a coil using the coiling start temperature of 620° C.

Samples having a sample width transverse to the rolling direction of 30 mm and a sample length in rolling direction of 110 mm have been taken from the respective coiled hot strips in order to determine the bending number before the occurrence of a crack according to DIN EN ISO 7799 with a bending radius of 5 mm at the middle of the strip width and at both edges of the strip in strip width direction 25 mm from the respective edge.

In addition, the average roughness on both surfaces Ra_{T} and the average roughness on both surfaces Ra_{R} of the hot strip was determined, wherein the roughness Ra_{T} is measured transverse to the rolling direction on the top and bottom side of the strip, in each case at least 15 m from the strip head or at least 15 m from the strip end with a measuring distance of 100 mm according to DIN EN ISO 4287:2010, an average value being formed from these measurements, and the roughness Ra_{R} is measured in rolling direction on the top and bottom side of the strip, in each case at least 15 m from the strip head or at least 15 m from the strip end with a measuring distance of 100 mm according to DIN EN ISO 4287:2010, an average value being formed from these measurements. Results of these measurements are shown in Table 2.

After that, the hot strips were annealed in a two-step annealing process with a first maximum temperature of 1050° C., cooled to a second temperature of 900° C. and then to room temperature at a cooling rate of 30 K/s. The cooled hot strips were cold rolled in a single stage without intermediate annealing into cold strips having a final thickness of 0.22 mm. After cold rolling, the number of cold-rolling breakages CRB was calculated and is shown in Table 2.

The cold strips underwent decarburization annealing for 150 s including a nitriding treatment, both at an annealing temperature of 850° C. with a nitriding degree of 100 ppm. After application of an annealing separator mainly comprising MgO onto the strip surface, final annealing of the coated decarburization annealed cold strips with a temperature of 1210° C. to form a Goss texture was carried out.

The final annealed cold strips were coated with an electric insulation coating containing a metal phosphate, colloidal silica and a chromium compound, and subsequently annealed for relieving stresses and baking of the coating. Domain refinement of the coated cold strips was carried out.

Measurements of polarization J₈₀₀ and iron loss P_{1.7} according to IEC 60404-3 were carried out. Furthermore, sets of Epstein samples, having the following dimensions: 280 mm in rolling direction and 30 mm in transverse direction, were cut and iron loss P_{1.7} was determined according to IEC 60404-2 prior and after performing an aging test with the respective Epstein samples of the grain-oriented electrical steel sheets for 24 h at a temperature of 225° C. in ambient atmosphere.

In addition, the area fraction in % of grains having a grain size of 50 mm related to the total area of the grains in the steel was determined according to DIN EN ISO 643 in the rolling direction. All measurements were carried out at 50 Hz. The results are shown in Table 3.

Furthermore, the bending number of the grain-oriented electrical steel sheets was determined according to DIN EN ISO 7799 with a bending radius of 5 mm using a sample width transverse to the rolling direction of 30 mm and a sample length in rolling direction of 280 mm The results are shown in Table 3.

Finally, the chemical composition of the steel bulk of the grain oriented electrical steel sheets was determined after completion of the final processing, i.e., the laser domain refinement. The results are shown in Table 4.

The results in Tables 2 and 3 show that samples 4-1 to 8-3 according to the invention show an improved cold-rollability of the hot strip due to an improved ductility of the hot-rolled strip. At the same time the ductility of the final grain-oriented electrical steel strip is improved and excellent magnetic properties, in particular an improved iron loss, are achieved. In comparison, the comparative samples 1-1 to 3-3, which are outside of the scope of the invention show inferior cold-rollability due to inferior ductility of the hot rolled strip and of the final grain oriented electrical steel strip. The magnetic properties, in particular the iron loss, is obviously worse than the iron loss achieved by the inventive samples 4-1 to 8-3.

In addition, the results further show that the deterioration in magnetic properties due to aging is strongly reduced in the inventive samples 4-1 to 8-3 compared to the comparative samples 1-1 to 3-3.

TABLE 1
Composition of the different heats in wt. %. Underscored figures are outside of the claimed scope.

| Example | Mo | V | Nb | Ti | V + Nb + Ti + Mo | Cu | Si | C | Alₛₗ | N | Mn | S |
|---|---|---|---|---|---|---|---|---|---|---|---|---|
| heat-1 | 0.043 | 0.0003 | 0.0007 | 0.0011 | 0.0451 | 0.050 | 3.25 | 0.061 | 0.030 | 0.0087 | 0.15 | 0.004 |
| heat-2 | 0.009 | 0.0065 | 0.0039 | 0.0024 | 0.0218 | 0.009 | 3.08 | 0.057 | 0.032 | 0.0086 | 0.15 | 0.005 |
| heat-3 | 0.029 | 0.0058 | 0.0063 | 0.0025 | 0.0436 | 0.092 | 3.33 | 0.052 | 0.035 | 0.0082 | 0.15 | 0.040 |
| heat-4 | 0.004 | 0.002 | 0.0011 | 0.0011 | 0.0082 | 0.151 | 3.25 | 0.060 | 0.034 | 0.0085 | 0.15 | 0.010 |
| heat-5 | 0.0080 | 0.0009 | 0.0009 | 0.0020 | 0.0118 | 0.163 | 3.09 | 0.060 | 0.035 | 0.0090 | 0.15 | 0.0048 |
| heat-6 | 0.0100 | 0.0040 | 0.0012 | 0.0009 | 0.0161 | 0.092 | 3.33 | 0.059 | 0.039 | 0.0088 | 0.15 | 0.0050 |
| heat-7 | 0.0140 | 0.0021 | 0.0015 | 0.0014 | 0.0190 | 0.134 | 3.26 | 0.060 | 0.033 | 0.0087 | 0.15 | 0.0050 |
| heat-8 | 0.0080 | 0.0006 | 0.0035 | 0.0018 | 0.0139 | 0.211 | 3.30 | 0.061 | 0.035 | 0.0092 | 0.15 | 0.0051 |

TABLE 2
Properties of the hot strip determined at different stages of the method of the invention. Underscored figures are outside of the claimed scope.

| | | Bending | Bending | | | | | | | | | |
|---|---|---|---|---|---|---|---|---|---|---|---|---|
| | | test hot | test hot | Roughness | Roughness | Average | Roughness | Roughness | Average | | | |
| | Bending | strip | strip | TD | TD | TD | RD | RD | RD | Roughness | CRB | CRB/ |
| | test hot | “left | “left | Top | Bottom | Roughness | top | Bottom | Roughness | ratio | per | \|(2.0 − |
| Sample | strip“middle” | edge” | edge” | Ra_{T}1 | Ra_{T}2 | Ra_{T} | Ra_{R}1 | Ra_{R}2 | Ra_{R} | Ra_{T}/Ra_{R} | 1000 t | Si)\| |
| 1-1 | 4 | 5 | 5 | 0.41 | 0.45 | 0.43 | 0.92 | 0.93 | 0.93 | 0.46 | 35 | 28.0 |
| 1-2 | 4 | 6 | 4 | 0.39 | 0.40 | 0.40 | 0.89 | 0.93 | 0.91 | 0.43 | 36 | 28.8 |
| 1-3 | 3 | 6 | 4 | 0.38 | 0.40 | 0.39 | 0.88 | 0.90 | 0.89 | 0.44 | 36 | 28.8 |
| 2-1 | 5 | 5 | 6 | 1.48 | 1.45 | 1.47 | 3.23 | 3.29 | 3.26 | 0.45 | 29 | 26.9 |
| 2-2 | 6 | 7 | 4 | 1.45 | 1.43 | 1.44 | 3.20 | 3.31 | 3.26 | 0.44 | 27 | 25.0 |
| 2-3 | 6 | 7 | 4 | 1.52 | 1.48 | 1.50 | 3.18 | 3.28 | 3.23 | 0.46 | 28 | 25.9 |
| 3-1 | 3 | 4 | 5 | 2.98 | 2.90 | 2.94 | 1.20 | 1.18 | 1.19 | 2.47 | 49 | 36.8 |
| 3-2 | 3 | 3 | 3 | 3.00 | 2.85 | 2.93 | 1.20 | 1.15 | 1.18 | 2.49 | 50 | 37.6 |
| 3-3 | 2 | 4 | 4 | 2.90 | 2.95 | 2.93 | 1.19 | 1.13 | 1.16 | 2.52 | 47 | 35.3 |
| 4-1 | 10 | 10 | 11 | 0.73 | 0.73 | 0.73 | 0.81 | 0.80 | 0.81 | 0.91 | 29 | 23.2 |
| 4-2 | 9 | 11 | 12 | 0.72 | 0.73 | 0.73 | 0.79 | 0.89 | 0.84 | 0.86 | 29 | 23.2 |
| 4-3 | 12 | 12 | 10 | 0.70 | 0.70 | 0.70 | 0.79 | 0.85 | 0.82 | 0.85 | 28 | 22.4 |
| 5-1 | 12 | 14 | 12 | 0.92 | 0.90 | 0.91 | 1.51 | 1.50 | 1.51 | 0.60 | 22 | 20.2 |
| 5-2 | 11 | 13 | 10 | 0.96 | 0.96 | 0.96 | 1.56 | 1.45 | 1.51 | 0.64 | 21 | 19.3 |
| 5-3 | 13 | 16 | 14 | 1.00 | 0.98 | 0.99 | 1.54 | 1.48 | 1.51 | 0.66 | 23 | 21.1 |
| 6-1 | 5 | 8 | 6 | 1.23 | 1.25 | 1.24 | 0.75 | 0.77 | 0.76 | 1.63 | 42 | 31.6 |
| 6-2 | 7 | 8 | 7 | 1.20 | 1.20 | 1.20 | 0.77 | 0.77 | 0.77 | 1.56 | 43 | 32.3 |
| 6-3 | 7 | 6 | 7 | 1.18 | 1.21 | 1.20 | 0.75 | 0.73 | 0.74 | 1.61 | 43 | 32.3 |
| 7-1 | 9 | 8 | 7 | 1.36 | 1.33 | 1.35 | 1.05 | 1.05 | 1.05 | 1.28 | 37 | 29.4 |
| 7-2 | 9 | 6 | 7 | 1.38 | 1.35 | 1.37 | 1.07 | 1.04 | 1.06 | 1.29 | 35 | 27.8 |
| 7-3 | 9 | 7 | 8 | 1.40 | 1.37 | 1.39 | 1.05 | 1.08 | 1.07 | 1.30 | 35 | 27.8 |
| 8-1 | 9 | 7 | 10 | 0.65 | 0.68 | 0.67 | 1.27 | 1.29 | 1.28 | 0.52 | 40 | 30.8 |
| 8-2 | 8 | 7 | 9 | 0.65 | 0.69 | 0.67 | 1.28 | 1.35 | 1.32 | 0.51 | 43 | 33.1 |
| 8-3 | 10 | 8 | 8 | 0.67 | 0.64 | 0.66 | 1.28 | 1.32 | 1.30 | 0.50 | 41 | 31.5 |

TABLE 3
Properties of the grain oriented electrical steel strip. Underscored figures are outside of the claimed scope.

| | | I₈₀₉[T] | P_{1.7} [W/kg] | P_{1.7} [W/kg] | P_{1.7} [W/kg] | | |
|---|---|---|---|---|---|---|---|
| | % | before aging test | before aging test | before aging test | after aging test | | BN |
| | grains ≥50 | acc. to IEC | acc. to IEC | acc. to IEC | acc. to IEC | % P_{1.7} | final |
| Sample | mm | 60404-3 | 60404-3 | 60404-2 | 60404-2 | degradation | strip |
| 1-1 | 35 | 1.69 | 0.764 | 0.858 | 0.872 | 1.63% | 23 |
| 1-2 | 32 | 1.90 | 0.755 | 0.846 | 0.868 | 2.36% | 25 |
| 1-3 | 34 | 1.90 | 0.760 | 0.854 | 0.859 | 0.59% | 22 |
| 2-1 | 31 | 1.92 | 0.736 | 0.818 | 0.835 | 2.08% | 28 |
| 2-2 | 37 | 1.92 | 0.730 | 0.811 | 0.840 | 3.58% | 29 |
| 2-3 | 34 | 1.93 | 0.725 | 0.805 | 0.826 | 2.61% | 28 |
| 3-1 | 30 | 1.92 | 0.720 | 0.791 | 0.802 | 1.39% | 20 |
| 3-2 | 38 | 1.90 | 0.728 | 0.800 | 0.818 | 2.25% | 18 |
| 3-3 | 42 | 1.90 | 0.712 | 0.782 | 0.806 | 3.07% | 21 |
| 4-1 | 28 | 1.91 | 0.708 | 0.761 | 0.762 | 0.13% | 40 |
| 4-2 | 28 | 1.91 | 0.725 | 0.780 | 0.782 | 0.26% | 35 |
| 4-3 | 25 | 1.91 | 0.702 | 0.755 | 0.765 | 1.32% | 42 |
| 5-1 | 20 | 1.93 | 0.738 | 0.820 | 0.821 | 0.12% | 56 |
| 5-2 | 19 | 1.93 | 0.732 | 0.822 | 0.826 | 0.49% | 53 |
| 5-3 | 24 | 1.93 | 0.748 | 0.841 | 0.840 | −0.12% | 52 |
| 6-1 | 15 | 1.89 | 0.713 | 0.758 | 0.765 | 0.92% | 31 |
| 6-2 | 15 | 1.89 | 0.707 | 0.752 | 0.751 | −0.13% | 33 |
| 6-3 | 17 | 1.89 | 0.691 | 0.735 | 0.736 | 0.14% | 33 |
| 7-1 | 12 | 1.90 | 0.703 | 0.773 | 0.780 | 0.91% | 48 |
| 7-2 | 12 | 1.91 | 0.716 | 0.787 | 0.788 | 0.13% | 46 |
| 7-3 | 8 | 1.91 | 0.713 | 0.784 | 0.782 | −0.26% | 43 |
| 8-1 | 17 | 1.92 | 0.657 | 0.738 | 0.737 | −0.14% | 32 |
| 8-2 | 19 | 1.91 | 0.643 | 0.722 | 0.729 | 0.97% | 32 |
| 8-3 | 25 | 1.92 | 0.653 | 0.734 | 0.733 | −0.14% | 30 |

TABLE 4
Composition of the steel bulk of the grain oriented electrical steel sheets of the
different heats in wt. %. Underscored figures are outside of the claimed scope.

| Example | Mo | V | Nb | Ti | V + Nb + Ti + Mo | Cu | Si | C | Alsl | N | Mn | S | C + N |
|---|---|---|---|---|---|---|---|---|---|---|---|---|---|
| heat-1 | 0.0422 | 0.0003 | 0.0007 | 0.0012 | 0.0444 | 0.051 | 3.25 | 0.0029 | 0.0030 | 0.0037 | 0.15 | 0.0007 | 0.0066 |
| heat-2 | 0.0100 | 0.0066 | 0.0038 | 0.0022 | 0.0226 | 0.009 | 3.00 | 0.001 | 0.0041 | 0.0008 | 0.15 | 0.0008 | 0.0018 |
| heat-3 | 0.0293 | 0.0056 | 0.0063 | 0.0026 | 0.0438 | 0.091 | 3.33 | 0.0008 | 0.0028 | 0.0009 | 0.15 | 0.0019 | 0.0017 |
| heat-4 | 0.0040 | 0.0025 | 0.0012 | 0.0011 | 0.0088 | 0.151 | 3.25 | 0.0010 | 0.0029 | 0.0008 | 0.15 | 0.0007 | 0.0018 |
| heat-5 | 0.0083 | 0.0010 | 0.0010 | 0.0021 | 0.0124 | 0.160 | 3.09 | 0.0009 | 0.0025 | 0.0007 | 0.15 | 0.0019 | 0.0016 |
| heat-6 | 0.0099 | 0.0043 | 0.0011 | 0.0008 | 0.0161 | 0.092 | 3.33 | 0.0015 | 0.0022 | 0.0015 | 0.15 | 0.0017 | 0.003 |
| heat-7 | 0.0138 | 0.0020 | 0.0014 | 0.0012 | 0.0184 | 0.129 | 3.26 | 0.0009 | 0.0029 | 0.0017 | 0.15 | 0.0015 | 0.0026 |
| heat-8 | 0.0082 | 0.0005 | 0.0033 | 0.0019 | 0.01393 | 0.208 | 3.30 | 0.0018 | 0.0019 | 0.0009 | 0.15 | 0.0014 | 0.0027 |

1) A method of producing a grain-oriented electrical steel sheet comprising at least the following working steps:
a) providing a thin steel slab having a thickness of 30 to 140 mm with a composition comprising, in wt. %,
Si: 2.0 to 4.0,
C: 0.01 to 0.10,
Alₛₗ: 0.01 to 0.065,
N: 0.003 to 0.015,
Mn: 0.01 to 0.5,
at least one element selected from the group consisting of V, Nb, Ti, Mo with the following contents, in wt. %
V: 0.0005 to 0.0060,
Nb: 0.0005 to 0.0060,
Ti: 0.0005 to 0.0030,
Mo: 0.0005 to 0.040,
wherein in case the content of Mo is >0.010 wt. %, the sum of the contents of V, Nb, Ti and Mo is ≤0.040 wt. % and Cu is present in an amount of 0.02 to 0.6 wt. % and wherein in case the content of Mo is ≤0.010% the sum of the contents of V, Nb, Ti and Mo is ≤0.030 wt. % and Cu may optionally be present in an amount of 0.002 to 0.6 wt. %,
optionally one or more elements selected from the group consisting of Se, Sn, Sb, Bi, Ni, Co, wherein the individual content of each of these elements is 0.002 to 0.2 wt. %,
optionally Cr in an amount of 0.002 to 0.60 wt. %,
optionally S in an amount of 0.002 to 0.10 wt. %,
optionally one or more elements selected from the group consisting of As, B, P, Te, wherein the individual content of each of these elements is 0.0003 to 0.1 wt. %, the remainder of the composition being Fe and unavoidable impurities;
b) heating of the thin steel slab in a furnace standing inline to a temperature ranging between 105° and 1320° C. for at most 60 min;
c) continuous hot rolling of the thin steel slab obtained in step b) into a hot strip having a thickness of 0.5 to 4.0 mm in a multi-stand hot rolling mill standing inline, wherein the first rolling pass is carried out at a temperature of 900 to 1200° C. with a degree of deformation of more than 40%;
d) cooling the hot strip by vapor and/or liquid spray cooling;
e) coiling the hot strip;
f) annealing the hot strip;
g) cold rolling the hot strip in one or more steps into a cold strip, wherein the cold rolling optionally comprises an intermediate annealing;
h) decarburization annealing of the cold strip;
i) optionally nitriding annealing during or after decarburization annealing;
j) applying an annealing separator onto at least one surface of the cold strip;
k) final annealing of the cold strip;
l) optionally coating of the annealed cold strip with an electric insulation coating and annealing of the insulation coated cold strip; and
m) optionally performing domain refinement of the coated cold strip.

2) The method of producing a grain-oriented electrical steel strip according to claim 1, wherein the hot strip resulting after step e) and prior to step f) has a bending number of 5 measured at the middle of the strip width and a bending number of ≥6 measured at both edges of the strip in strip width direction 25 mm from the respective edge before the occurrence of a crack, determined according to DIN EN ISO 7799 with a bending radius of 5 mm.

3) The method of producing a grain-oriented electrical steel strip according to claim 1, wherein the ratio of the average roughness on both surfaces Ra_{T} and the average roughness on both surfaces Ra_{R} of the hot strip resulting after step e) and prior to step f) satisfies the following formula:
$$0.5 \leq {Ra}_{T} / {Ra}_{R} \leq 1.75$$
and wherein the roughness Ra_{T} is measured transverse to the rolling direction on the top and bottom side of the strip, in each case at least 15 m from the strip head or at least 15 m from the strip end with a measuring distance of 100 mm according to DIN EN ISO 4287:2010, an average value being formed from these measurements, and the roughness Ra_{R} is measured in rolling direction on the top and bottom side of the strip, in each case at least 15 m from the strip head or at least 15 m from the strip end with a measuring distance of 100 mm according to DIN EN ISO 4287:2010, an average value being formed from these measurements.

4) The method of producing a grain-oriented electrical steel strip according to claim 1, wherein depending on the amount of Si, in wt. %, in the thin steel slab provided in step a) the number of cold-rolling breakages in the cold-rolled strip after step g) satisfies the following formulae:
$$for 2. < Si < 3.1 \qquad CRB / \vert ( 2. - Si ) \vert < 25$$
$$for 3.1 \leq Si < 3.26 \qquad CRB / \vert ( 2. - Si ) \vert < 30$$
$$\begin{matrix}for 3.26 \leq Si \leq 4. & CRB / \vert ( 2. - Si ) \vert < 35\end{matrix} ,$$
wherein CRB is the number of cold-rolling breakages per 1000 t cold-rolled strip.

5) The method of producing a grain-oriented electrical steel strip according to claim 1, wherein the slab surface temperature at inline furnace entrance is between 800° C. and 1100° C.

6) The method of producing a grain-oriented electrical steel strip according to claim 1, wherein the duration of the annealing in step b) is between 5 min to 60 min.

7) The method of producing a grain-oriented electrical steel strip according to claim 1, wherein the coiling of the hot strip is carried out at a temperature of 500° C. to 780° C.

8) The method of producing a grain-oriented electrical steel strip according to claim 1, wherein step f) is carried out in a single or multi-step annealing, wherein the maximum temperature is at 800 to 1200° C. and the hot strip is annealed in total for 30 seconds to 6 minutes.

9) The method of producing a grain-oriented electrical steel strip according to claim 1, wherein production step g) is carried out by rolling in multiple passes, wherein the temperature T_{CR} of the surface of the strip determined directly after third and second last pass before reaching the final steel thickness is between 175 and 480° C.

10. A grain-oriented electrical steel sheet, wherein the steel bulk of the grain-oriented electrical steel comprises, in wt. %:
Si: 2.0 to 4.0,
Mn: 0.01 to 0.5,
C: up to 0.005,
Alₛₗ: up to 0.0030,
N: up to 0.005;
wherein the sum of C and N is max. 0.0065%;
at least one element selected from the group consisting of V, Nb, Ti, Mo with the following contents, in wt. %, V: 0.0005 to 0.0060, Nb: 0.0005 to 0.0060, Ti: 0.0005 to 0.0030, Mo: 0.0005 to 0.040;
wherein in case the content of Mo is >0.010 wt. %, the sum of the contents of V, Nb, Ti and Mo is ≤0.040 wt. % and Cu is present in an amount of 0.02 to 0.6 wt. % and wherein in case the content of Mo is ≤0.010% the sum of the contents of V, Nb, Ti and Mo is ≤0.030 wt. % and Cu is optionally present in an amount of 0.002 to 0.6 wt. %, optionally S in an amount of max. 0.002 wt. %;
optionally one or more elements selected from the group consisting of Se, Sn, Sb, Bi, Ni, Co, Mg, wherein the individual content of each of these elements is 0.002 to 0.2 wt. %,
optionally Cr in an amount of 0.002 to 0.60 wt. %,
optionally one or more elements selected from the group consisting of As, B, P, Te,
wherein the individual content of each of these elements is 0.0003 to 0.1 wt. %, the remainder of the composition being Fe and unavoidable impurities.

11. The grain-oriented electrical steel sheet according to claim 10, wherein the grain-oriented electrical steel sheet is produced from a thin slab with a thickness of 30 to 140 mm and has a polarization J₈₀₀ of at least 1.89 T determined according to IEC 60404-3 and an iron loss P_{1.7} 0.85 W/kg determined according to IEC 60404-3.

12. The grain-oriented electrical steel sheet according to claim 10, wherein the grain-oriented electrical steel sheet has a coarse grain structure in which up to 30% of the grain area in relation to the total area of the grains in the steel is occupied by grains having a grain size, measured according to DIN EN ISO 643 in rolling direction, of 50 mm.

13. The grain-oriented electrical steel sheet according to claim 10, wherein the increase in iron loss P_{1.7} is 1.0% after performing an aging test with Epstein samples of the grain-oriented electrical steel sheet for 24 h at a temperature of 225° C. in ambient atmosphere according to IEC 60404-2.

14. The grain-oriented electrical steel sheet according to claim 10, wherein the grain-oriented electrical steel sheet has a bending number of ≥30 before the occurrence of a crack, determined according to DIN EN ISO 7799 with a bending radius of 5 mm.
